(19) United States
(12) Patent Application Publication
(10) Pub. No.: US 2013/0155517 A1
(43) Pub. Date: Jun. 20, 2013

(54) OPTICAL FILM AND METHOD OF MANUFACTURING THE SAME

(71) Applicants: Kyoung Gon PARK, Uiwang-si (KR); Ki Yong KIM, Uiwang-si (KR); Su Kyong LEE, Uiwang-si (KR); Mi Jeong CHOI, Uiwang-si (KR)

(72) Inventors: Kyoung Gon PARK, Uiwang-si (KR); Ki Yong KIM, Uiwang-si (KR); Su Kyong LEE, Uiwang-si (KR); Mi Jeong CHOI, Uiwang-si (KR)

(21) Appl. No.: 13/713,282

(22) Filed: Dec. 13, 2012

(30) Foreign Application Priority Data
Dec. 15, 2011 (KR) 10-2011-0135724

(51) Int. Cl. G02B 5/02

(52) U.S. Cl. CPC G02B 5/021; G02B 5/0268
USPC 359/599; 427/162

(57) ABSTRACT

An optical film including a base film, a light spreading pattern on a first surface of the base film, a surface of the light spreading pattern facing away from the base film being an undulating surface, and a light collecting pattern on a second surface of the base film.

### CROSS-REFERENCE TO RELATED APPLICATION

The present application claims priority under 35 U.S.C. §119 to Korean Patent Application No. 10-2011-0135724, filed on Dec. 15, 2011, in the Korean Intellectual Property Office, and entitled: “Optical Film and Method of Manufacturing the Same,” which is incorporated by reference herein in its entirety.

### BACKGROUND

1. Field

Example embodiments relate to an optical film and a method of manufacturing the same.

2. Description of the Related Art

A polarizing plate includes a polarizer capable of polarizing light in a specific direction and a protective layer for supporting and protecting the polarizer. Generally, the polarizer is fabricated by dyeing a polyvinyl alcohol film with dichroic iodine, followed by crosslinking the polyvinyl alcohol film with boric acid or the like.

In order to provide a light spreading effect to an optical film, a light spreading layer is formed on one side of a base film by coating the base film with a resin containing light spreading particles. For example, the coating of the base film may be performed by wet coating, e.g., a microgravure process, a slot die process, and the like, followed by UV and/or heat treatment of the coated layer.

Here, the light spreading effect is obtained by light-scattering due to the light spreading particles on the surface of the film, and an internal refraction caused by a difference in indices of refraction between the resin and the light spreading particles therein. At least one type of light spreading particle is used in the optical film, and the light spreading particles have a size ranging from a few to dozen micrometers and are present in an amount of a few to dozens of parts by weight based on the weight of the resin.

Further, to regulate viscosity in wet coating, at least one volatile organic solvent having a relatively low boiling point is used in an amount of a few to dozens of parts by weight based on the weight of the resin. For example, the light spreading particles are dispersed in a mixture of the resin and the organic solvent. However, the organic solvent may cause environmental contamination and health problems of operators in manufacture of the optical film.

### SUMMARY

Example embodiments provide an optical film with a light spreading surface having a light spreading pattern thereon that improves appearance and characteristics of the optical film.

Example embodiments also provide an optical film with a light spreading surface having a light spreading pattern thereon that allows easy regulation of surface roughness, haze value, and the like.

Example embodiments also provide a method of manufacturing an optical film with a light spreading surface having a light spreading pattern thereon by using a semi-permanent mold, instead of light spreading particles and an organic solvent, thereby ensuring eco-friendliness, safety, and economical feasibility.

One aspect of the example embodiments provides an optical film, including a base film, a light spreading pattern on a first surface of the base film, the light spreading pattern including no light spreading particles, and a light collecting pattern on a second surface of the base film.

The light spreading pattern may have an average haze value ranging from about 1% to about 99%.

The light spreading pattern may have a standard deviation of the haze value of about 1.5%.

The light spreading pattern may have a surface roughness Ra from about 0.01 μm to about 2 μm.

The light collecting pattern may have a brightness uniformity of about 80% or more.

The light spreading pattern may consist of a curable resin.

One aspect of the example embodiments also provides an optical film, including a base film, a light spreading pattern on a first surface of the base film, a surface of the light spreading pattern facing away from the base film being an undulating surface, and a light collecting pattern on a second surface of the base film.

The light spreading pattern may consist essentially of a curable resin. The light spreading pattern may include no dispersed phase.

One aspect of the example embodiments also provides a method of manufacturing an optical film, including forming an undulating pattern on a mold, transferring the undulating pattern from the mold to a first side of a base film to form a light spreading pattern, and forming a light collecting pattern on a second surface of the base film.

Forming the undulating pattern on the mold may include using a metal roll as the mold, the metal roll including at least one of steel, aluminum, and alloys thereof, and coating a first coating layer on the metal roll, the first coating layer including at least one of nickel, copper, chromium, aluminum, alloys thereof, ceramic, and DLC.

The method may further include coating a second coating layer on the first coating layer.

Coating the second coating layer may include coating on the first coating layer at least one of nickel, copper, chromium, aluminum, alloys thereof, and ceramic.

The undulating pattern of the mold may be formed by sand-blasting, etching, laser processing, or drilling the mold.

The undulating pattern of the mold may be formed by sand-blasting the mold, the sand-blasting being performed about 1˜50 times using beads.

The beads may be prepared by mixing one or more types of particles having an average particle diameter of about 0.1 μm to about 1,000 μm.

The beads may be organic beads including at least one of polyester resins, olefin resins, acrylic resins, urethane resins, acryl-urethane resins, epoxy resins and silicone resins, inorganic beads including at least one of glass and ceramic, or composite beads of organic and inorganic beads.

The base film may be formed of at least one of polyester resins, olefin resins, acrylic resins, urethane resins, acryl-urethane resins, epoxy resins, and silicone resins.

The base film may be formed to have a thickness ranging from about 10 μm to about 1,000 μm.

Forming the light spreading pattern on the base film may include coating a curable resin on the base film, pressing the undulating pattern into the curable resin, and curing the curable resin, such that the light spreading pattern is formed of the curable resin.

The light spreading pattern may be formed to include no light spreading particles.

### BRIEF DESCRIPTION OF THE DRAWINGS

Features will become apparent to those of ordinary skill in the art by describing in detail exemplary embodiments with reference to the attached drawings in which:

FIG. 1 illustrates a cross-sectional view of an optical film according to an embodiment;

FIG. 2 illustrates a flowchart of a process of forming a light spreading pattern in an optical film according to an embodiment; and

FIG. 3 illustrates a conceptual view of a method of manufacturing an optical film according to an embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

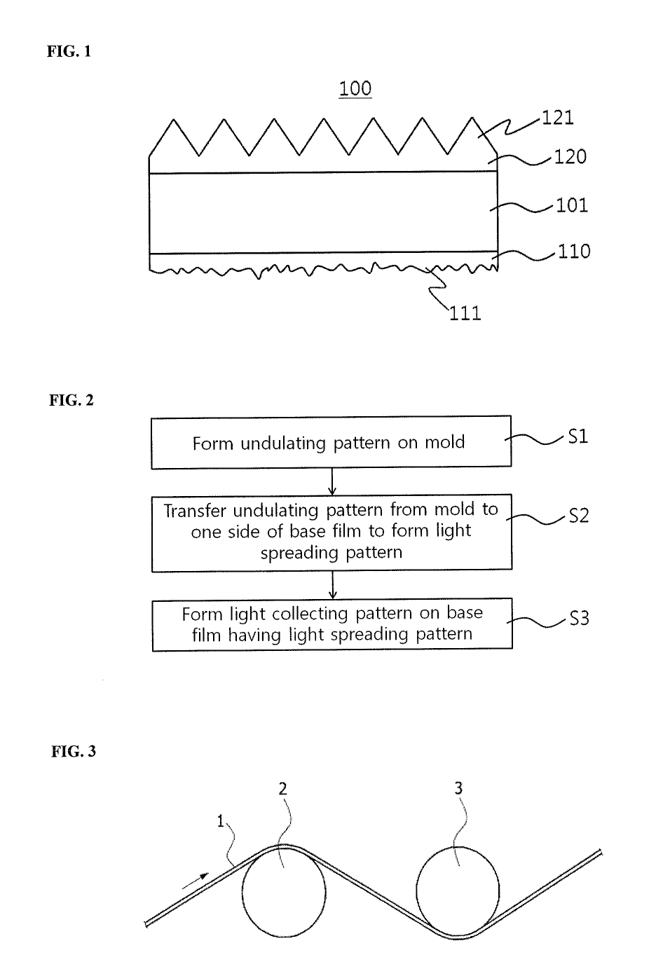

An optical film according to an embodiment will be described with reference to FIG. 1. FIG. 1 is a cross-sectional view of an optical film according to an embodiment.

Referring to FIG. 1, an optical film 100 may include a base film 101, a light spreading pattern 111 formed on one side of the base film 101, and a light collecting pattern 121 formed on the other side of the base film 101. That is, the light spreading pattern 111 and the light collecting pattern 121 may be formed on opposite surfaces of the base film 101.

The base film 101 may be a single layer or multi-layer, e.g., formed by stacking two or more layers. The base film 101 may include a single component resin or a multi-component resin, e.g., one or more of polyester resins, olefin resins, acryl resins, urethane resins, acryl-urethane resins, epoxy resins, silicone resins, and the like. For example, the base film 101 may be formed as a single layer of one resin (single component resin), or as multiple layers formed of two or more types of resins. However, example embodiments are not limited thereto, and any suitable film applicable to an optical film may be used as the base film 101 without limitation, e.g., the base film 101 may be a single layer of polyethylene terephthalate (PET).

The base film 101 may have a thickness ranging from about 10 μm to about 1,000 μm according to application conditions, without being limited thereto.

The light spreading pattern 111 may be formed on one side of the base film 101, e.g., on a first surface of the base film 101. In some embodiments, the light spreading pattern 111 may be formed on one side of a light spreading layer 110, which is formed on one side of the base film 101. For example, the light spreading layer 110 may be formed between the first surface of the base film 101 and the light spreading pattern 111.

The light spreading pattern 111 may have a surface roughness equal to wavelengths of visible light or higher. The light spreading pattern 111 may exhibit an average haze value of about 1% to about 90%, e.g., about 5% to about 85%, and a positional standard deviation of about 1.5% or less, e.g., about 0.5% to about 1.5%, irrespectively of the haze value.

In a conventional light spreading pattern, a degree of particle dispersion within a medium, e.g., within a resin, decreases with an increased haze value, thereby causing increase in the standard deviation. However, in the light spreading pattern 111 according to example embodiments, the standard deviation is maintained at a substantially constant level, irrespectively of the haze value, e.g., even if the haze value increases. For example, the positional standard deviation may be standard deviation of haze values that are measured at points of 0 m, 200 m, 400 m, 600 m, 800 m, and 1,000 m from a start point of the optical film in a longitudinal or width direction.

In detail, the light spreading pattern 111 may have an average, e.g., an arithmetic average, surface roughness Ra of about 0.01 μm to about 2 μm, an average, e.g., a ten-point, maximum surface roughness Rz of about 0.1 μm to about 5 and a maximum height, e.g., peak-to-valley, of a profile Ry of about 1 μm to about 10 μm, as measured by a 3D tester. Within the above range, diffusion efficiency by surface scattering is increased, thereby improving shielding capabilities.

The light spreading pattern 111 may be formed of a UV-curable resin, e.g., the light spreading pattern 111 may consist essentially of a UV-curable resin, so the light spreading pattern 111 may include no light spreading particles. For example, the light spreading pattern 111 may be formed of a UV-curable resin, e.g., a UV-curable resin containing an oligomer having an acryl group, a monomer, a photoinitiator, and additives. The oligomer may be, e.g., a urethane acrylate, an acrylic acrylate, or the like, without being limited thereto. The light spreading pattern 111 may be formed in a surface of the light spreading layer 110 by a mold, as will be discussed in more detail below with reference to FIG. 2.

The light collecting pattern 121 may be formed on the other side of the base film 101, e.g., on a second surface of the base film 101 opposite the first surface. In some embodiments, the light collecting pattern 121 may be formed on one side of a light collecting layer 120 formed on the other side of the base film 101. For example, the light collecting layer 120 may be formed between the second surface of the base film 101 and the collecting pattern 121. The light collecting pattern 121 may have a triangular cross-section in a direction perpendicular to the base film 101, without being limited thereto. That is, the light collecting pattern 121 may have any suitable cross-sectional shape, e.g., a circle, an oval, a frustum, and the like, that provides a light-collecting function. The light collecting pattern 121 may have a brightness uniformity of about 80% or more, as measured by a BM-7 brightness tester (Topcon Co., Ltd.).

The light collecting layer 120 and the light collecting pattern 121 may be formed, e.g., integrally, of a UV-curable resin, e.g., a UV-curable resin containing an oligomer having an acryl group, a monomer, a photoinitiator, and additives. The oligomer may include, e.g., urethane acrylate, acrylic acrylate, or the like, without being limited thereto.

Now, a method of manufacturing the optical film 100 according to an embodiment will be described with reference to FIGS. 1 to 3. FIG. 2 is a flowchart of a method of manufacturing the optical film 100, and FIG. 3 is

Referring to FIG. 2, the method of manufacturing the optical film 100 may include forming a pattern on a mold (S1), transferring the pattern from the mold to one side of a base film to form a light spreading pattern (S2), and forming a light collecting pattern on the other side of the base film opposite the side on which the light spreading pattern is formed (S3). For example, the pattern formed in operation S1 is transferred from the mold to the first surface of the base film 101 to form the light spreading pattern 111 on the base film 101, followed by forming the light collecting pattern 121 on the second surface of the base film 101.

In a conventional process of forming a light spreading pattern in an optical film, wet coating may be used to coat a polymer resin solution containing light spreading particles and a volatile organic solvent on a base film. However, dispersion of the light spreading particles within the polymer resin solution may become unstable over time, thereby reducing the light spreading performance of the optical film.

However, in the method according to the example embodiments, the light spreading particles and volatile organic solvent within the polymer resin are not employed when forming the light spreading pattern. Therefore, light spreading performance of the optical film 100 is not affected by the dispersed state of the light spreading particles, thereby improving brightness uniformity.

In detail, referring to FIG. 2, the pattern, e.g., the undulating pattern, is first formed on the mold (S1). The mold may be a metal roll formed of metal, e.g., at least one of steel, aluminum, and alloys thereof. The metal roll may include a first coating layer, e.g., a plating layer, thereon, so the pattern may be formed in the first coating layer. The first coating layer may include, e.g., at least one of nickel, copper, chromium, aluminum, alloys thereof, ceramic, diamond-like carbon (DLC), or the like. Since the first coating layer on the metal roll has a relatively low hardness, e.g., as compared to the metal roll without the first coating layer, the pattern, e.g., the undulating pattern, can be easily formed in the first coating layer, e.g., by sand-blasting or the like, and a haze value can be easily adjusted according to application of optical films.

As the pattern is formed on the mold by sand-blasting or the like, the pattern may introduce a surface roughness to the first coating layer. For example, sand blasting the first coating layer may form tiny microcavities in a surface of the first coating layer to define an undulating pattern on the surface of the first coating layer, i.e., an unsmooth surface on the first coating layer.

For example, the metal in the metal roll may refer to a single-element metal, or an alloy including two or more elements. Since the metal roll with the first coating layer has to be effectively patterned, e.g., by sand blasting, etching, laser processing, drilling or the like, and has to be reused according to application thereof, the metal roll may be formed of a reusable metallic material that has a relatively soft surface and can maintain an original shape thereof, e.g., the mold may be formed of metal having the first coating layer formed, i.e., plated, thereon.

The metal roll may further include a second coating layer formed on the first coating layer. The second coating layer may include at least one of e.g., nickel, copper, chromium, aluminum, alloys thereof, ceramic, and mixtures thereof. The second coating layer may have a thickness of about 0.1 μm to about 1,000 μm. The second coating layer may include a single layer or multiple layers formed of single or different metallic materials. By formation of the second coating layer, the mold may have improved durability and surface roughness. For example, the first coating layer may be formed on the mold by copper plating to improve adhesion, and the second coating layer may be formed on the first coating layer by nickel plating to improve surface roughness.

For example, sand blasting may be performed about 1˜50 times using beads to form the undulating layer. The beads may include a single type of particles, or two or more types of particles having an average particle size of about 0.1 μm to about 1,000 μm. Herein, the term “single type” means that the material and the particle size are the same. The beads may be organic beads include at least one of, e.g., polyester resins, olefin resins, acryl resins, urethane resins, acryl-urethane resins, epoxy resins and silicone resins, inorganic beads including at least one of, e.g., glass and ceramic, and composite beads including organic beads and inorganic beads.

Surface roughness of the light spreading pattern 111 increases with increasing strength and blasting pressure of the beads. Thus, it is desirable that sand blasting conditions, e.g., bead strength, blasting pressure, and the like, be set in consideration of a haze value of a desired light spreading pattern and formation conditions of the second coating layer after formation of the pattern on the mold.

The surface roughness and haze value of the light spreading pattern 111 can be easily adjusted by adjusting the sand blasting conditions, e.g., type, size, blasting pressure, and blasting times, of the beads. For example, when forming a conventional light spreading pattern by wet coating, a high haze value results in reduced dispersion stability of the light spreading particles in the polymer resin solution, thereby causing increase in standard deviation. On the contrary, in the process of forming the light spreading pattern 111 according to the example embodiments, the standard deviation may be maintained at a substantially constant level, regardless of changes in the haze value. For example, the standard deviation can be maintained at 1 or less, even at a high average haze value of about 65% or more.

Next, referring to FIGS. 1 and 2, the undulating pattern may be transferred from the mold to one side of the base film 101 to form the light spreading pattern 111 (S2). For example, a curable resin may be injected between the base film 101 and the mold having the undulating pattern, such that the mold having the undulating pattern may be positioned on the base film 101 with the curable resin therebetween, i.e., with the undulating pattern contacting the curable resin. The undulating pattern may be transferred from the mold to the curable resin by curing the curable resin. As a result, the light spreading layer 110 formed of the curable resin may be formed on the first surface of the base film 101, and the light spreading pattern 111 may be formed on the light spreading layer 110.

Further, before, after, or simultaneously with formation of the light spreading pattern 111 on the first surface of the base film 101, the light collecting pattern 121 may be formed on the second surface of the base film 101 opposite the first surface of the base film 101 having the light spreading pattern 111 thereon (S3). For example, after operation S2, the light collecting pattern 121 may be formed on the other side of the base film 101, or otherwise, while performing operation S2, the light collecting pattern 121 may be formed on the other side of the base film 101. Here, when a metal roll for forming the light spreading pattern 111 and an engraving roll for forming the light collecting pattern 121 (a prism layer) are used at the same time, process efficiency can be improved. However, example embodiments are not limited thereto.

In detail, a curable resin may be injected between the base film 101 and the engraving roll having the light collecting pattern 121. Therefore, when the engraving roll presses against the curable resin, while contacting the curable resin, the curable resin is cured, thereby allowing the light collecting pattern 121 to be transferred from the engraving roll to the curable resin. Thus, the light-collecting layer 120 formed of the curable resin may be formed on the other side of the base film 101, and the light collecting pattern (e.g. a prism pattern) 121 may be formed on one side of the light-collecting layer 120. The light collecting pattern 121 may be formed by any typical method, and the present invention is not limited thereto.

Further, when the base film 101 has a multilayer structure including the light spreading layer 111 and the light-collecting layer 121, UV- or thermal-curing may be performed after operations S2 and S3.

FIG. 3 illustrates a conceptual view of the method of manufacturing the optical film 100 according to example embodiments. As shown in FIG. 3, while a base film 1 is brought into contact with a mold 2, e.g., a metal roll, having an undulating pattern thereon, the undulating pattern of the mold 2 is transferred onto the side of the base film 1 contacting the mold 2. Then, while the other side, i.e., an opposite surface, of the base film 1 is brought into contact with an engraving roll 3 for forming a light collecting pattern (a prism layer), the light collecting pattern is formed on the other side of the base film 1, thereby forming an optical film according to an embodiment. The sequence of forming the light spreading pattern 111 and the light collecting pattern 121 can be changed.

For example, the mold 2 for forming the light spreading pattern 111 and the engraving roll 3 for forming the light collecting pattern 121 may be used sequentially to form the light spreading pattern 111 and the light-collecting pattern 121, respectively. In another example, the mold 2 for the formation of the light spreading pattern 111 and the engraving roll 3 for the formation of the light collecting pattern 121 may be used simultaneously, e.g., may simultaneously contact opposite surfaces of the base film 1, to form the light spreading pattern 111 and the light-collecting pattern 121.

The optical film according to example embodiments may include a molded light spreading pattern with a desired dispersion feature, instead of light spreading particles disposed within a polymer, thereby preventing reduced optical characteristics caused by non-uniform dispersion of light spreading particles.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

To form an undulating pattern on a mold, a nickel layer was plated on a mold, i.e., on a steel roll. Next, the nickel-plated layer was sand-blasted 10 times at an injection pressure of 500 MPa using poly-dispersive glass beads having a particle size of 1-45 μm to form the undulating pattern on the nickel-plated steel roll. Then, the nickel-plated steel roll having the undulating pattern was subjected to post-nickel plating at 100 mA for 10 minutes to form a 1 μm thick nickel coating layer on the steel roll, thereby finalizing a mold, i.e., steel roll, having an undulating pattern formed thereon, i.e., patterned nickel coating.

Then, a UV-curable resin was injected into a space between one side of a 250 μm thick PET film and the steel roll having the undulating pattern, e.g., the UV-curable resin was injected on the PET film. The steel roll was moved toward the one side of the PET film while contacting a UV-curable resin, so the undulating pattern formed on the steel roll contacted the PET film via the UV-curable resin. The UV-curable resin was cured by UV irradiation, e.g., sequentially or simultaneously, so the undulating pattern was transferred from the roll to the one side of the PET film to form a light spreading pattern. A light collecting pattern was formed on the other side of the PET film by transferring a prism pattern to the other side of the PET film through the same process as the process of forming the light spreading pattern, except for the use of a roll having the prism pattern formed thereon. The UV-curable resin included 50 parts per 100 parts of UV-curable resin of an acrylic oligomer (Kuremul BSA, Hannong Chemicals Inc.), 45 parts per 100 parts of UV-curable resin of an acrylic monomer (OPGE-001, Hannong Chemicals Inc.), and 5 parts per 100 parts of UV-curable resin of a photoinitiator (Additol TPO, SK Cytec Co., Ltd.).

### Example 2

An optical film was prepared in the same manner as in Example 1, except that the undulating pattern was formed by reciprocally sand-blasting 5 times at an injection pressure of 400 MPa using the poly-dispersive glass beads.

### Comparative Example 1

A polymer resin solution was prepared as follows. A solid mix of 40% of poly-dispersive PS (HR59-80, Sunjin Chemical Co., Ltd.), 30% of a urethane acrylate (Ebecryl 1290, SK Cytec Co., Ltd.), 15% r of an acrylic monomer (TPGDA, SK Cytec Co., Ltd.), 10% of an acrylic monomer (TMPTA, SK Cytec Co., Ltd.), 3% of an acrylic monomer (DPHA, SK Cytec Co., Ltd.), 1% r of photoinitiator (Irgacure 184, Ciba Co., Ltd.), and 1% of silicone additives (HS-300, SK Cytec Co., Ltd.) was prepared to define a solid content of 40%, followed by mixing the solid content with 60% of an organic solvent (MEK:Toluene=1:1) to prepare the polymer resin solution. The polymer resin solution was mixed with a dispersion device to provide sufficient particle dispersion therein. A 250 μm thick PET film having a prism pattern (light collecting pattern) on one side thereof was prepared, and the polymer resin solution was coated on the other side of the PET film using a microgravure coater, followed by UV curing, to form a light spreading layer.

### Comparative Example 2

A light spreading layer was formed in the same manner as in Comparative Example 1, except that the polymer resin solution included a solid content of 35% with organic solvents (65%, MEK:Toluene=1:1). The solid content of the polymer resin solution included 2% of mono-dispersive PMMA (MX500, Soken Co., Ltd.), 50% of a urethane acrylate (Ebecryl 1290, SK Cytec Co., Ltd.), 15% of an acrylic monomer (HDDA, SK Cytec Co., Ltd.), 18% of an acrylic monomer (TETIA, SK Cytec Co., Ltd.), 11% of an acrylic monomer (DPHA, SK Cytec Co., Ltd), 1% of a photoinitiator (Irgacure 184, Ciba Co., Ltd.) and 3% of silicone additives (HS-300, SK Cytec Co., Ltd.).

The following table 1 shows conditions for Examples 1 and 2 and Comparative Examples 1 and 2.

TABLE 1

| | | | | | | Comparative | Comparative |
|---|---|---|---|---|---|---|---|
| | | Example 1 | | Example 2 | | Example 1 | Example 2 |
| Method of forming light | | Patterning | | Patterning | | Wet coating | Wet coating |
| spreading pattern | | (Sand-blasting) | | (Sand-blasting) | | (Microgravure) | (Microgravure) |
| Sand-blasting | Presence | O | | O | | X | X |
| condition | Type | Glass beads | | Glass beads | | — | — |
| | Size | poly-dispersive | | poly-dispersive | | — | — |
| | | 1~45 | μm | 1~45 | μm | | |
| | Pressure | 500 | MPa | 400 | MPa | — | — |
| | Time | 10 | times | 5 | times | — | — |

| | | | | | |
|---|---|---|---|---|---|
| Light spreading | Presence | X | X | O | O |
| particle | Type | — | — | PS | PMMA |
| | Size | — | — | Poly-dispersive | Mono-dispersive |
| | | | | 8 μm | 10 μm |
| | Content | — | — | 40% | 2% |
| Organic particle | Presence | X | X | O | O |
| | Type | — | — | MEK, Toluene | MEK, Toluene |
| | Content | — | — | 60% | 65% |

The haze value of the light spreading pattern of each of the optical films prepared in the examples and the comparative examples was measured using a haze tester NDH5000W (Nippon Denshoku Co., Ltd.) according to ASTM D1003 by obtaining samples from a central portion of the optical film at points of 0 m, 200 m, 400 m, 600 m, 800 m and 1,000 m from a start point of the optical film while recording average values and standard deviations thereof.

Results of measurement of the haze values in Examples 1 and 2 and Comparative Examples 1 and 2 are shown in Table 2.

TABLE 2

| | | | | | Comparative | Comparative |
|---|---|---|---|---|---|---|
| Roll # | Point | | Example 1 | Example 2 | Example 1 | Example 2 |
| 1 | 0 | m | 70.4 | 2.9 | 67.0 | 3.4 |
| | 200 | m | 70.5 | 2.9 | 62.0 | 4.3 |
| | 400 | m | 70.7 | 3.0 | 60.5 | 3.0 |
| | 600 | m | 69.4 | 3.0 | 70.2 | 3.3 |
| | 800 | m | 70.5 | 2.9 | 71.0 | 1.9 |
| | 1000 | m | 70.4 | 3.0 | 62.0 | 2.5 |
| 2 | 0 | m | 70.1 | 3.0 | 73.2 | 2.4 |
| | 200 | m | 70.7 | 3.0 | 69.0 | 2.8 |
| | 400 | m | 69.2 | 3.1 | 72.5 | 1.9 |
| | 600 | m | 70.5 | 3.0 | 74.3 | 4.1 |
| | 800 | m | 70.2 | 3.0 | 70.0 | 3.3 |
| | 1000 | m | 69.7 | 3.0 | 62.0 | 3.1 |
| 3 | 0 | m | 70.4 | 2.9 | 65.7 | 2.8 |
| | 200 | m | 70.7 | 2.9 | 66.8 | 1.7 |
| | 400 | m | 70.7 | 3.0 | 70.2 | 1.9 |
| | 600 | m | 70.5 | 3.0 | 72.5 | 3.3 |
| | 800 | m | 70.2 | 3.0 | 68.0 | 3.3 |
| | 1000 | m | 69.7 | 2.9 | 62.0 | 4.4 |
| 4 | 0 | m | 69.4 | 2.9 | 69.0 | 1.8 |
| | 200 | m | 70.2 | 3.0 | 70.2 | 2.9 |
| | 400 | m | 70.1 | 3.0 | 74.3 | 2.8 |
| | 600 | m | 70.7 | 2.9 | 62.0 | 2.6 |
| | 800 | m | 70.2 | 3.1 | 74.0 | 2.8 |
| | 1000 | m | 69.7 | 3.0 | 72.0 | 2.1 |
| 5 | 0 | m | 70.5 | 3.0 | 72.5 | 1.9 |
| | 200 | m | 70.7 | 2.9 | 66.9 | 3.8 |
| | 400 | m | 70.5 | 2.9 | 70.0 | 1.7 |
| | 600 | m | 69.7 | 3.1 | 69.0 | 4.2 |
| | 800 | m | 70.2 | 3.0 | 74.3 | 3.8 |
| | 1000 | m | 69.7 | 3.0 | 71.0 | 1.9 |

| | | | | |
|---|---|---|---|---|
| Haze average (%) | 70.2 | 3.0 | 68.8 | 2.9 |
| Haze standard | 0.4 | 0.1 | 4.3 | 0.8 |
| deviation | | | | |

In Comparative Examples 1 and 2, in which wet coating was performed on the film using the microgravure coater, the haze value significantly increased as the number of rolls increased. On the contrary, in Examples 1 and 2, the haze value was relatively uniform (small standard deviation).

In particular, there was a significant difference between the comparative examples and the inventive examples in terms of variation in haze uniformity at a high haze value of 65% or more.

The optical film of Example 2 exhibited a low standard deviation of 0.1% (average haze value: 3.0%) and the optical film of Comparative Example 2 exhibited a low standard deviation of 0.8% (average haze value of 2.9%). That is, when the optical film had a low average haze value of about 3%, i.e., as in Example 2 and Comparative Example 2, there was no significant difference in standard deviation between the example and the comparative example. On the other hand, the optical film of Example 1 exhibited a standard deviation of 0.4% (average haze value: 70.2%) and the optical film of Comparative Example 1 exhibited a standard deviation of 4.3% (average haze value of 68.8%), which was much higher than that of the optical film of Example 1. That is, when the optical film has a high average haze value of about 70%, i.e., as in Example 1 and Comparative Example 1, there was a significant difference in standard deviation between the example and the comparative example.

Thus, it can be seen that the optical films of the inventive example did not exhibit significant variation in haze uniformity and the optical films of the comparative examples exhibited significant deterioration in haze uniformity when the haze value was increased. Consequently, it can be seen that the optical film and its manufacturing method according to example embodiments exhibits superior haze uniformity, as compared to conventional art.

Table 3 shows results of evaluation of characteristics of the optical films prepared in Example 1 and Comparative Example 1.

Evaluation method of physical properties:

(1) Adhesive strength: a coating film was cut into a 10×10 lattice shape by cross cutting. An adhesive tape was used to detach the cut squares off the coating film to measure adhesive strength of the coating film according to ASTM D3002.

(2) Surface hardness: Scratch resistance of the coating film was observed using pencils having different hardness values according to ASTM D3363.

(3) Central brightness: Central brightness was measured using a brightness tester BM-7 (Topcon Co., Ltd).

(4) Brightness uniformity: Brightness according to locations was measured using a brightness tester BM-7 (Topcon Co., Ltd) to measure brightness uniformity.

TABLE 3

| Characteristics | | | Example 1 | Comparative Example I |
|---|---|---|---|---|
| Light spreading | Preparation method | | Patterning | Wet coating |
| pattern | | | (sand-blasting + coating) | (Microgravure) |
| | Haze value | Average | 70.2% | 68.8% |
| | | Standard | 0.4% | 4.3% |
| | | deviation | | |

| | | | |
|---|---|---|---|
| | Adhesion | 100% | 100% |
| | Surface hardness | 2H | 2H |
| Light collecting | Central brightness (Max.) | 5,900 nit (100%) | 5,860 nit (99%) |
| pattern | Brightness uniformity | 80% | 78% |

In Table 3, it can be seen that in the optical film manufacturing method according to example embodiments, the light spreading pattern having a high haze value has improved haze uniformity and can improve brightness uniformity after formation of the light collecting pattern (prism layer), as compared with an optical film having a light spreading layer with light spreading particles.

Example embodiments have been disclosed herein, and although specific terms are employed, they are used and are to be interpreted in a generic and descriptive sense only and not for purpose of limitation. Accordingly, it will be understood by those of skill in the art that various changes in form and details may be made without departing from the spirit and scope of the present invention as set forth in the following claims

What is claimed is:

1. An optical film, comprising:
a base film;
a light spreading pattern on a first surface of the base film, the light spreading pattern including no light spreading particles; and
a light collecting pattern on a second surface of the base film.

2. The optical film as claimed in claim 1, wherein the light spreading pattern has an average haze value ranging from about 1% to about 99%.

3. The optical film as claimed in claim 1, wherein the light spreading pattern has a standard deviation of the haze value of about 1.5%.

4. The optical film as claimed in claim 1, wherein the light spreading pattern has a surface roughness Ra from about 0.01 μm to about 2 μm.

5. The optical film as claimed in claim 1, wherein the light collecting pattern has a brightness uniformity of about 80% or more.

6. The optical film as claimed in claim 1, wherein the light spreading pattern consists of a curable resin.

7. The optical film as claimed in claim 1, wherein the light spreading pattern is an undulated pattern.

8. An optical film, comprising:
a base film;
a light spreading pattern on a first surface of the base film, a surface of the light spreading pattern facing away from the base film being an undulating surface; and
a light collecting pattern on a second surface of the base film.

9. A method of manufacturing an optical film, the method comprising:
forming an undulating pattern on a mold;
transferring the undulating pattern from the mold to a first side of a base film to form a light spreading pattern; and
forming a light collecting pattern on a second surface of the base film.

10. The method as claimed in claim 9, wherein forming the undulating pattern on the mold includes:
using a metal roll as the mold, the metal roll including at least one of steel, aluminum, and alloys thereof; and
coating a first coating layer on the metal roll, the first coating layer including at least one of nickel, copper, chromium, aluminum, alloys thereof, ceramic, and DLC.

11. The method as claimed in claim 10, further comprising coating a second coating layer on the first coating layer.

12. The method as claimed in claim 11, wherein coating the second coating layer includes coating on the first coating layer at least one of nickel, copper, chromium, aluminum, alloys thereof, and ceramic.

13. The method as claimed in claim 9, wherein the undulating pattern of the mold is formed by sand-blasting, etching, laser processing, or drilling the mold.

14. The method as claimed in claim 13, wherein the undulating pattern of the mold is formed by sand-blasting the mold, the sand-blasting being performed about 1˜50 times using beads.

15. The method as claimed in claim 14, wherein the beads are prepared by mixing one or more types of particles having an average particle diameter of about 0.1 μm to about 1,000 μm.

16. The method as claimed in claim 14, wherein the beads are organic beads including at least one of polyester resins, olefin resins, acrylic resins, urethane resins, acryl-urethane resins, epoxy resins and silicone resins, inorganic beads including at least one of glass and ceramic, or composite beads of organic and inorganic beads.

17. The method as claimed in claim 9, wherein the base film is formed of at least one of polyester resins, olefin resins, acrylic resins, urethane resins, acryl-urethane resins, epoxy resins, and silicone resins.

18. The method as claimed in claim 9, wherein the base film is formed to have a thickness ranging from about 10 μm to about 1,000 μm.

19. The method as claimed in claim 9, wherein forming the light spreading pattern on the base film includes:
coating a curable resin on the base film;
pressing the undulating pattern into the curable resin; and
curing the curable resin, such that the light spreading pattern is formed of the curable resin.

20. The method as claimed in claim 9, wherein the light spreading pattern is formed to include no light spreading particles.
